(19) United States
(12) Patent Application Publication
(10) Pub. No.: US 2010/0196747 A1
(43) Pub. Date: Aug. 5, 2010

(54) BATTERY PACK

(75) Inventor: Takashi Takeda, Kanagawa (JP)

Correspondence Address: IPUSA, P.L.L.C, 1054 31ST STREET, N.W., Suite 400, Washington, DC, 20007, US

(73) Assignee: MITSUMI ELECTRIC CO., LTD., Tokyo (JP)

(21) Appl. No.: 12/664,936

(22) PCT Filed: Jun. 25, 2008
(86) PCT No.: PCT/JP2008/061519

§ 371 Date: Dec. 16, 2009

(30) Foreign Application Priority Data
Jun. 25, 2007 (JP) 2007-166665

(51) Int. Cl. H01M 10/02

(52) U.S. Cl. 429/61

(57) ABSTRACT

A battery pack having a protection circuit to detect an overcharge, overdischarge, or overcurrent condition of a secondary battery and to turn off a switch element on a path connecting between the secondary battery and either a load or a charger device includes a series-connected thermistor and resistor disposed in proximity of the secondary battery and connected in parallel to the secondary battery, and a first comparator in the protection circuit to compare a voltage at a junction point between the thermistor and the resistor with a first reference voltage corresponding to a first predetermined temperature, wherein the protection circuit turns off the switch element by an output signal of the first comparator upon an exceeding of the first predetermined temperature by temperature of the secondary battery.

### TECHNICAL FIELD

The present invention relates to battery packs, and relates to a battery pack provided with a protection circuit to detect an overcharge, overdischarge, or overcurrent condition of a secondary battery and to turn off a switch element on a path connecting between the secondary battery and either a load or a charger device.

### BACKGROUND ART

In recent years, lithium ion batteries have been used in portable apparatuses such as digital cameras. A lithium ion battery is easy to damage from overcharging or overdischarging, and is thus provided in a battery pack having a circuit to provide protection from overcharging and overdischarging.

FIG. 4 and FIG. 5 are block diagrams illustrating examples of related-art battery packs. In FIG. 4, a series-connected resistor R1 and condenser C1 are connected to a lithium ion battery 2 in parallel. The positive terminal of the lithium ion battery 2 is coupled to an external terminal 3 of a battery pack 1. The negative terminal is coupled to an external terminal 4 of the battery pack 1 through n-channel MOS (metal-oxide semiconductor) transistors M1 and M2 provided for current interruption purposes.

The drains of the MOS transistors M1 and M2 are connected to each other. The source of the MOS transistor M1 is connected to the negative terminal of the lithium ion battery 2. The source of the MOS transistor M2 is connected to the external terminal 4. Body diodes D1 and D2 are connected in an equivalent fashion between the drain and source of the MOS transistors M1 and M2, respectively.

A protection IC (integrated circuit) 5 has an overcharge detection circuit, an overdischarge detection circuit, and an overcurrent detection circuit embedded therein. The protection IC 5 operates with a power supply voltage Vdd supplied from the positive terminal of the lithium ion battery 2 through the resistor R1 and a power supply voltage Vss supplied from the negative terminal of the lithium ion battery 2.

The protection IC 5 changes the DOUT output to a low level when the overdischarge detection circuit or overcurrent detection circuit detects an overdischarge or overcurrent condition, thereby making the MOS transistor M1 nonconductive. The protection IC 5 changes the COUT output to a low level when the overcharge detection circuit detects an overcharge condition, thereby making the MOS transistor M2 nonconductive.

In FIG. 5, a thermistor R3 is further provided in the battery pack 1. One end of the thermistor R3 is connected to a terminal 6 of the battery pack 1, and the other end is connected to the external terminal 4. The terminal 6 of the battery pack 1 receives a predetermined voltage from the charger device via a potential dividing resistor during a charge operation. The resistance of the thermistor R3 varies in response to the temperature of the battery pack 1, which causes a change in the voltage at the terminal 6. The charger device detects the voltage at the terminal 6, and suspends the charge operation when the temperature of the battery pack 1 exceeds a predetermined temperature.

Patent Document 1 discloses a battery pack having a PTC thermistor that is thermally coupled to a switching element for interrupting a current path used for a charge or discharge operation.

[Patent Document 1] Japanese Patent Application Publication No. 2006-32015

### DISCLOSURE OF INVENTION

### Problem to be Solved by Invention

The related-art configuration illustrated in FIG. 4 provides no protection function with respect to the temperature of the battery pack. On the other hand, the related-art configuration illustrated in FIG. 5 has a protection function with respect to the temperature of the battery pack. Since the predetermined voltage is applied by the charger device through a potential dividing resistor, however, a change in the predetermined voltage generated by the charger device or variation in the potential dividing resistor of the charger device makes it impossible to accurately detect the temperature of the battery pack.

The technology disclosed in Patent Document 1 employs a PTC thermistor. This gives rise to a problem in that protection is not possible in the case of a lowering in battery pack temperature while protection is possible in the case of an increase in battery pack temperature.

In consideration of the foregoing points, it is a general object of the present invention to provide a battery pack that can accurately detect the temperature of a secondary battery and can provide accurate temperature protection for the secondary battery.

### Means to Solve the Problem

According to an embodiment of the present invention, a battery pack having a protection circuit (15) to detect an overcharge, overdischarge, or overcurrent condition of a secondary battery and to turn off a switch element (M11, M12) on a path connecting between the secondary battery (12) and either a load or a charger device includes: a series-connected thermistor (R13) and resistor (R14) disposed in proximity of the secondary battery (12) and connected in parallel to the secondary battery; and a first comparator (21) in the protection circuit to compare a voltage at a junction point between the thermistor (R13) and the resistor (R14) with a first reference voltage (V1) corresponding to a first predetermined temperature, wherein the protection circuit turns off the switch element (M11, M12) by an output signal of the first comparator (21) upon an exceeding of the first predetermined temperature by temperature of the secondary battery, thereby making it possible to provide accurate temperature protection for the secondary battery by accurately detecting the temperature of the secondary battery.

The above-noted battery pack may include a second comparator (31) in the protection circuit to compare the voltage at the junction point between the thermistor (R13) and the resistor (R14) with a second reference voltage (V2) corresponding to a second predetermined temperature lower than the first predetermined temperature, wherein the protection circuit may be configured to turn off the switch element (M11, M12) by an output signal of the second comparator (31) upon a lowering of the temperature of the secondary battery below the second predetermined temperature.

In the above-noted battery pack, the thermistor (R13) may be an NTC thermistor having a negative temperature coefficient.

The reference symbols in parentheses are provided only as examples for the purpose of facilitating understanding, and are never intended to limit the elements to the illustrated embodiments.

### ADVANTAGE OF THE INVENTION

According to the present invention, the temperature of the secondary battery is accurately detected, and accurate temperature protection is provided for the secondary battery.

### BRIEF DESCRIPTION OF DRAWINGS

FIG. 1 is a block diagram illustrating a first embodiment of a battery pack according to the present invention.

FIG. 2 is a drawing of temperature-resistance characteristics of an NTC thermistor and a PTC thermistor.

FIG. 3 is a block diagram illustrating a second embodiment of a battery pack according to the present invention.

FIG. 4 is a block diagram illustrating an example of a related-art battery pack.

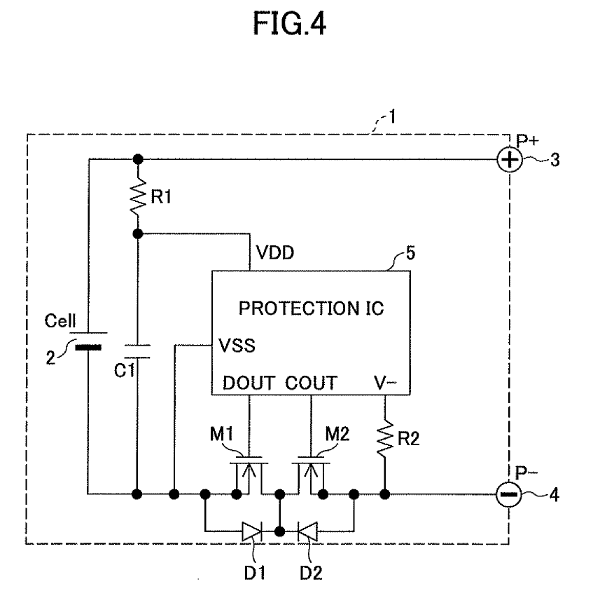

FIG. 5 is a block diagram illustrating another example of a related-art battery pack.

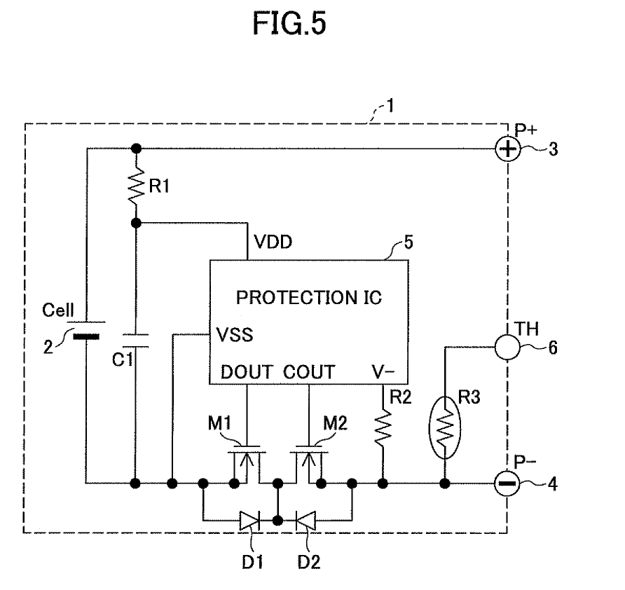

### DESCRIPTION OF REFERENCE NUMBERS

10 Battery Pack
12 Lithium Ion Battery
13, 14 External Terminal
15 Protection IC
16 Overcharge Detection Circuit
17 Overdischarge Detection Circuit
18 Overcurrent Detection Circuit
19 Logic Circuit
20, 30 Constant Voltage Source
21, 31 Comparator
22, 32 Unresponsive-time Setting Circuit
C11 Condenser
M11, M12 MOS Transistor
R11, R12, R14 Resistor
R13 Thermistor

### BEST MODE FOR CARRYING OUT THE INVENTION

### First Embodiment

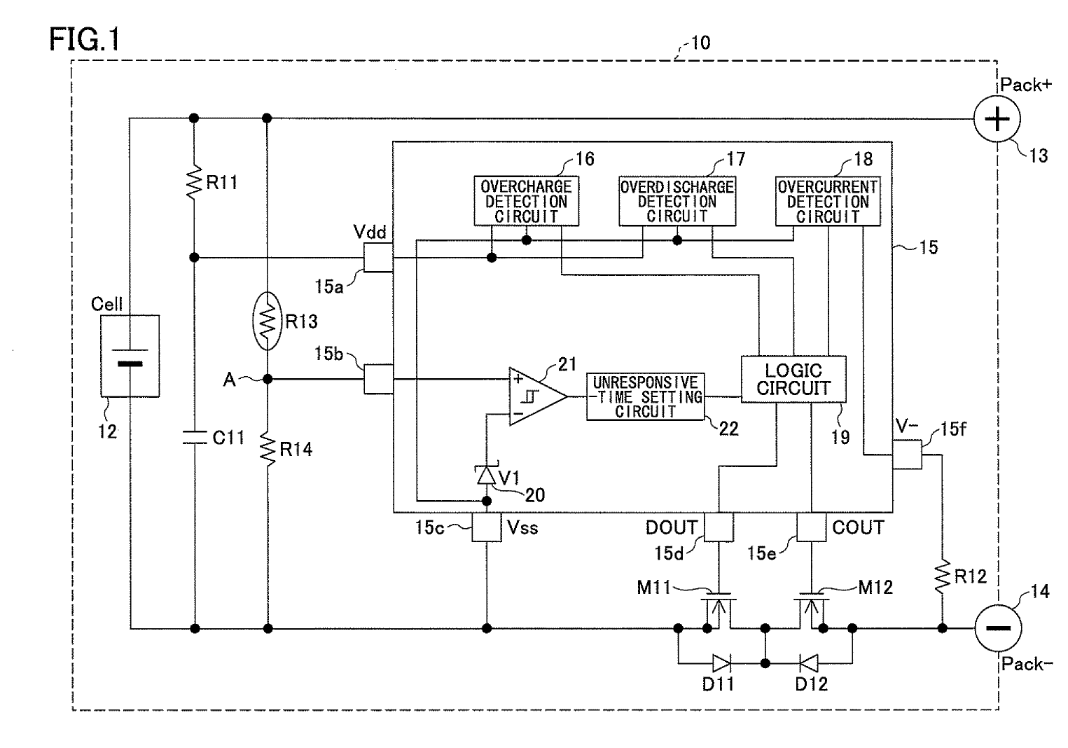

FIG. 1 is a block diagram illustrating a first embodiment of a battery pack according to the present invention. In the figure, a series-connected resistor R11 and condenser C11 are connected to a lithium ion battery 12 in parallel. The positive terminal of the lithium ion battery 12 is coupled through a wire connection to an external terminal 13 of a battery pack 10. The negative terminal is coupled through a wire connection to an external terminal 14 of the battery pack 10 through n-channel MOS transistors M11 and M12 provided for current interruption purposes.

The drains of the MOS transistors M11 and M12 are connected to each other. The source of the MOS transistor M11 is connected to the negative terminal of the lithium ion battery 12. The source of the MOS transistor M12 is connected to the external terminal 14. Body diodes D11 and D12 are connected in an equivalent fashion between the drain and source of the MOS transistors M11 and M12, respectively.

Further, a series-connected thermistor R13 and resistor R14 are connected to the lithium ion battery 12 in parallel. The thermistor R13 is disposed in the proximity of the lithium ion battery 12 in the battery pack 10, and is thermally coupled to the lithium ion battery 12. An NTC (negative temperature coefficient) thermistor having a negative temperature coefficient is used as the thermistor R13.

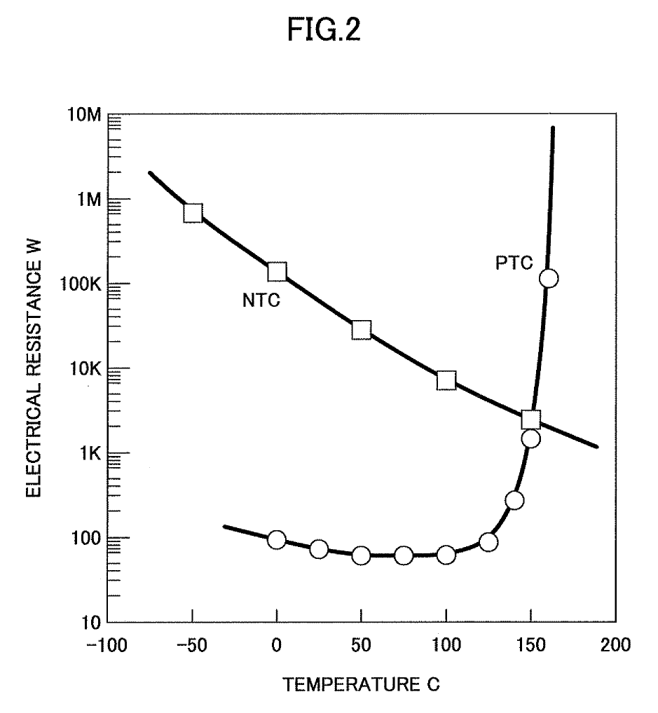

FIG. 2 is a drawing illustrating temperature-resistance characteristics for an NTC thermistor having a negative temperature coefficient and a PTC (positive temperature coefficient) thermistor having a positive temperature coefficient.

A protection IC 15 has an overcharge detection circuit 16, an overdischarge detection circuit 17, and an overcurrent detection circuit 18 embedded therein. The protection IC 15 operates with a power supply voltage Vdd supplied at a terminal 15a from the positive terminal of the lithium ion battery 12 through the resistor R11 and a power supply voltage Vss supplied at a terminal 15c from the negative terminal of the lithium ion battery 12.

The overcharge detection circuit 16 detects overcharging of the lithium ion battery 12 based on the voltages at the terminals 15a and 15c to apply a detection signal to a logic circuit 19. The overdischarge detection circuit 17 detects overdischarging of the lithium ion battery 12 based on the voltages at the terminals 15a and 15c to apply a detection signal to the logic circuit 19. The overcurrent detection circuit 18 detects an overcurrent condition based on the voltages at the terminals 15c and 15f in which a current flowing through the resistor R12 becomes excessive, thereby to apply a detection signal to the logic circuit 19.

Further, a terminal 15b of the protection IC 15 is connected to a junction point A between the thermistor R13 and the resistor R14. The terminal 15f is connected to one end of the resistor R12. The other end of the resistor R12 is connected to the external terminal 14. A terminal 15d of the protection IC 15 for a DOUT output is connected to the gate of the MOS transistor M11, and a terminal 15e of the protection IC 15 for a COUT output is connected to the gate of the MOS transistor M12.

In the protection IC 15, the terminal 15b is connected to a non-inverted input terminal of a comparator 21. The terminal 15c is connected to the negative terminal of a constant voltage source 20 such as a Zener diode. The positive terminal of the constant voltage source 20 is connected to the inverted input terminal of the comparator 21.

The thermistor R13 is a NTC thermistor having a negative temperature coefficient as illustrated in FIG. 2. The resistance of the thermistor R13 decreases as the temperature increases, thereby raising the voltage appearing at the junction point A.

The comparator 21 has hysteresis characteristics, and compares a constant voltage V1 generated by the constant voltage source 20 with the voltage appearing at the junction point A. The comparator 21 outputs a high-level signal when the voltage at the junction point A is higher. Namely, the comparator 21 outputs a high-temperature detection signal placed at a high level when the temperature detected by the thermistor R13 exceeds a predetermined temperature (e.g., approximately 70 degrees Celsius) corresponding to the constant voltage V1.

The high-temperature detection signal output from the comparator 21 is supplied to an unresponsive-time setting circuit 22. The unresponsive-time setting circuit 22 applies a high-temperature detection signal at a high level to the logic circuit 19 when the high-level period of the received high-temperature detection signal exceeds a predetermined length (e.g., 0.5 seconds).

The logic circuit 19 receives the detection signals from the overcharge detection circuit 16, the overdischarge detection circuit 17, and the overcurrent detection circuit 18, respectively, and also receives the high-temperature detection signal output from the unresponsive-time setting circuit 22.

The logic circuit 19 changes the COOT output at the terminal 15e to a low level upon receiving the overcharge detection signal from the overcharge detection circuit 16, thereby making the MOS transistor M12 nonconductive. The logic circuit 19 changes the DOUT output at the terminal 15d to a low level upon receiving the overdischarge detection signal from the overdischarge detection circuit 17, thereby making the MOS transistor M11 nonconductive. The logic circuit 19 changes the DOUT output at the terminal 15d to a low level upon receiving the overcurrent detection signal from the overcurrent detection circuit 18, thereby making the MOS transistor M11 nonconductive.

Moreover, the logic circuit 19 changes the COOT output at the terminal 15e to a low level to make the MOS transistor M12 nonconductive upon a change of the high-temperature detection signal to a high level. The DOUT output and COOT output at the terminals 15d and 15e may both be changed to a low level to make the MOS transistors M11 and M12 nonconductive.

The embodiment described above can accurately detect the temperature of the lithium ion battery 12, thereby providing protection by suspending charging or charging and discharging upon detecting a high temperature of the lithium ion battery 12.

As illustrated in FIG. 2, the resistance value of the NTC thermistor changes with temperature substantially in a linear fashion. The use of such an NTC thermistor as the thermistor R13 makes it possible to detect temperature accurately. Further, the provision of the thermistor R13 in the proximity of the lithium ion battery 12 in the battery pack 10 makes it possible to accurately detect the temperature of the lithium ion battery 12. It should be noted that accurate temperature detection is not possible with a PTC thermistor because its resistance value exhibits a sudden increase above a certain temperature.

### Second Embodiment

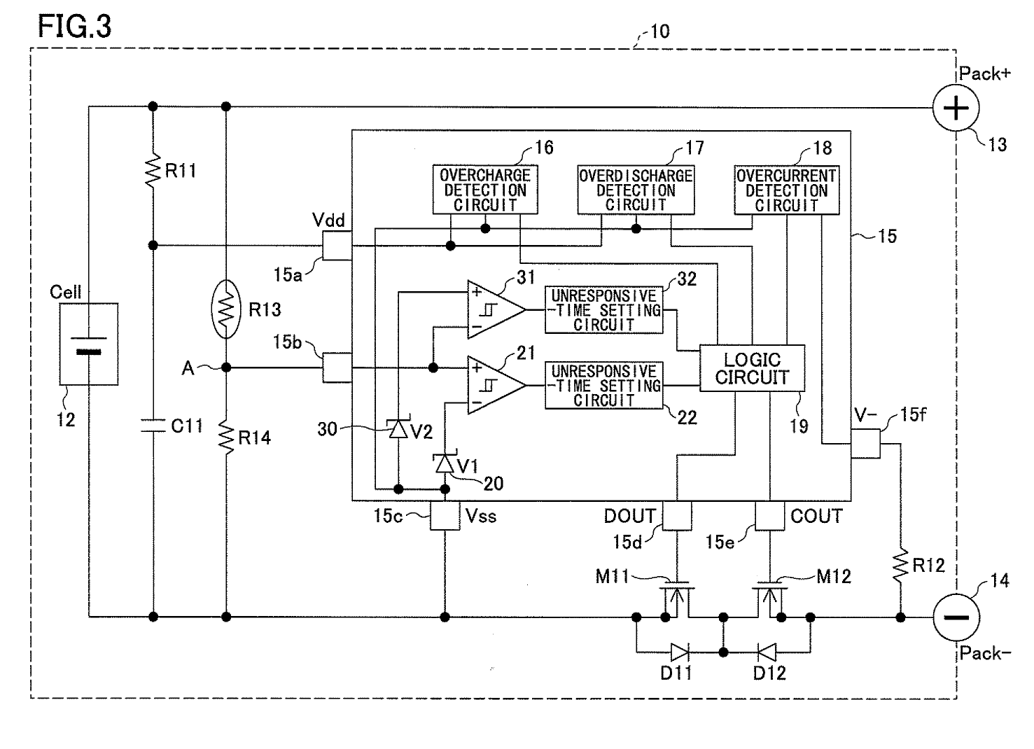

FIG. 3 is a block diagram illustrating a second embodiment of a battery pack according to the present invention. In this figure, the same elements as those of FIG. 1 are referred to by the same numerals.

In FIG. 3, the series-connected resistor R11 and condenser C11 are connected to the lithium ion battery 12 in parallel. The positive terminal of the lithium ion battery 12 is coupled to the external terminal 13 of the battery pack 10. The negative terminal is coupled to the external terminal 14 of the battery pack 10 through the n-channel MOS transistors M11 and M12 provided for current interruption purposes.

The drains of the MOS transistors M11 and M12 are connected to each other. The source of the MOS transistor M11 is connected to the negative terminal of the lithium ion battery 12. The source of the MOS transistor M12 is connected to the external terminal 14. Body diodes D11 and D12 are connected in an equivalent fashion between the drain and source of the MOS transistors M11 and M12, respectively.

Further, the series-connected thermistor R13 and resistor R14 are connected to the lithium ion battery 12 in parallel. The thermistor R13 is disposed in the proximity of the lithium ion battery 12 in the battery pack 10, and is thermally coupled to the lithium ion battery 12. An NTC thermistor having a negative temperature coefficient is used as the thermistor R13.

The protection IC 15 has the overcharge detection circuit 16, the overdischarge detection circuit 17, and the overcurrent detection circuit 18 embedded therein. The protection IC 15 operates with the power supply voltage Vdd supplied at the terminal 15a from the positive terminal of the lithium ion battery 12 through the resistor R11 and the power supply voltage Vss supplied at the terminal 15c from the negative terminal of the lithium ion battery 12.

The overcharge detection circuit 16 detects overcharging of the lithium ion battery 12 based on the voltages at the terminals 15a and 15c to apply a detection signal to the logic circuit 19. The overdischarge detection circuit 17 detects overdischarging of the lithium ion battery 12 based on the voltages at the terminals 15a and 15c to apply a detection signal to the logic circuit 19. The overcurrent detection circuit 18 detects an overcurrent condition based on the voltages at the terminals 15c and 15f in which a current flowing through the resistor R12 becomes excessive, thereby to apply a detection signal to the logic circuit 19.

Further, the terminal 15b of the protection IC 15 is connected to the junction point A between the thermistor R13 and the resistor R14. The terminal 15f is connected to one end of the resistor R12. The other end of the resistor R12 is connected to the external terminal 14. The terminal 15d of the protection IC 15 for the DOUT output is connected to the gate of the MOS transistor M11, and the terminal 15e of the protection IC 15 for the COUT output is connected to the gate of the MOS transistor M12.

In the protection IC 15, the terminal 15b is connected to the non-inverted input terminal of the comparator 21. The terminal 15c is connected to the negative terminal of the constant voltage source 20 such as a Zener diode. The positive terminal of the constant voltage source 20 is connected to the inverted input terminal of the comparator 21. Further, the terminal 15b is connected to an inverted input terminal of a comparator 31. The terminal 15c is connected to the negative terminal of a constant voltage source 30 such as a Zener diode. The positive terminal of the constant voltage source 30 is connected to the non-inverted input terminal of the comparator 31.

The thermistor R13 is a NTC thermistor having a negative temperature coefficient as illustrated in FIG. 2. The resistance of the thermistor R13 decreases as the temperature increases, thereby raising the voltage appearing at the junction point A.

The comparator 21 has hysteresis characteristics, and compares a constant voltage V1 generated by the constant voltage source 20 with the voltage appearing at the junction point A. The comparator 21 outputs a high-level signal when the voltage at the junction point A is higher. Namely, the comparator 21 outputs a high-temperature detection signal placed at a high level when the temperature detected by the thermistor R13 exceeds a predetermined temperature (e.g., approximately 70 degrees Celsius) corresponding to the constant voltage V1.

The high-temperature detection signal output from the comparator 21 is supplied to the unresponsive-time setting circuit 22. The unresponsive-time setting circuit 22 applies a high-temperature detection signal at a high level to the logic circuit 19 when the high-level period of the received high-temperature detection signal exceeds a predetermined length (e.g., 0.5 seconds).

The comparator 31 has hysteresis characteristics, and compares a constant voltage V2 generated by the constant voltage source 30 with the voltage appearing at the junction point A. The comparator 31 outputs a high-level signal when the voltage at the junction point A is lower. Namely, the comparator 31 outputs a lower-temperature detection signal placed at a high level when the temperature detected by the thermistor R13 drops below a predetermined temperature (e.g., approximately −20 degrees Celsius) corresponding to the constant voltage V2. It should be noted that discharging at low temperature needs to be avoided for the lithium ion battery 12, which has a battery capacity that drops at low temperature.

The low-temperature detection signal output from the comparator 31 is supplied to an unresponsive-time setting circuit 32. The unresponsive-time setting circuit 32 applies a low-temperature detection signal at a high level to the logic circuit 19 when the high-level period of the received high-temperature detection signal exceeds a predetermined length (e.g., 0.5 seconds).

The logic circuit 19 receives the detection signals from the overcharge detection circuit 16, the overdischarge detection circuit 17, and the overcurrent detection circuit 18, respectively, and also receives the high-temperature detection signal output from the unresponsive-time setting circuit 22.

The logic circuit 19 changes the COUT output at the terminal 15e to a low level upon receiving the overcharge detection signal from the overcharge detection circuit 16, thereby making the MOS transistor M12 nonconductive. The logic circuit 19 changes the DOUT output at the terminal 15d to a low level upon receiving the overdischarge detection signal from the overdischarge detection circuit 17, thereby making the MOS transistor M11 nonconductive. The logic circuit 19 changes the DOUT output at the terminal 15d to a low level upon receiving the overcurrent detection signal from the overcurrent detection circuit 18, thereby making the MOS transistor M11 nonconductive.

Moreover, the logic circuit 19 changes the DOUT output at the terminal 15d to a low level to make the MOS transistor M11 nonconductive upon a change of either the high-temperature detection signal or the low-temperature detection signal to a high level. The DOUT output and COUT output at the terminals 15d and 15e may both be changed to a low level to make the MOS transistors M11 and M12 nonconductive.

The embodiment described above can accurately detect the temperature of the lithium ion battery 12, thereby providing protection by suspending discharging or charging and discharging upon detecting a high temperature or low temperature of the lithium ion battery 12.

The temperature range of the battery pack used as a power supply for a portable phone or headset is approximately from −20 degrees Celsius to 70 degrees Celsius. Discharging and charging of the lithium ion battery 12 may be suspended outside this temperature range.

The order of arrangement of the thermistor R13 and the resistor R14 may be reversed, such that the thermistor R13 is connected to the negative terminal of the lithium ion battery 12. In such a case, the inputs of the comparators 21 and 31 may be swapped such that the terminal 15b is connected to the inverted input terminal of the comparator 21 and to the non-inverted input terminal of the comparator 31.

The present application claims foreign priority to Japanese Patent Application No. 2007-166665 filed on Jun. 25, 2007, the entire contents of which are incorporated herein by reference.

1. A battery pack having a protection circuit to detect an overcharge, overdischarge, or overcurrent condition of a secondary battery and to turn off a switch element on a path connecting between the secondary battery and either a load or a charger device, comprising:
a series-connected thermistor and resistor disposed in proximity of the secondary battery and connected in parallel to the secondary battery; and
a first comparator in the protection circuit to compare a voltage at a junction point between the thermistor and the resistor with a first reference voltage corresponding to a first predetermined temperature,
wherein the protection circuit turns off the switch element by an output signal of the first comparator upon an exceeding of the first predetermined temperature by temperature of the secondary battery.

2. The battery pack as claimed in claim 1, further comprising:
a second comparator in the protection circuit to compare the voltage at the junction point between the thermistor and the resistor with a second reference voltage corresponding to a second predetermined temperature lower than the first predetermined temperature,
wherein the protection circuit turns off the switch element by an output signal of the second comparator upon a lowering of the temperature of the secondary battery below the second predetermined temperature.

3. The battery pack as claimed in claim 1, wherein the thermistor is an NTC thermistor having a negative temperature coefficient.
